(19) United States
(12) Patent Application Publication
(10) Pub. No.: US 2012/0127275 A1
(43) Pub. Date: May 24, 2012

(54) IMAGE PROCESSING METHOD FOR DETERMINING DEPTH INFORMATION FROM AT LEAST TWO INPUT IMAGES RECORDED WITH THE AID OF A STEREO CAMERA SYSTEM

(76) Inventors: Henning Von Zitzewitz, Hildesheim (DE); Wolfgang Niehsen, Salzdetfurth (DE); Axel Wendt, Stuttgart (DE)

(21) Appl. No.: 13/320,236

(22) PCT Filed: May 7, 2010
(86) PCT No.: PCT/EP10/56270

§ 371 Date: Jan. 24, 2012

(30) Foreign Application Priority Data
May 14, 2009 (DE) 10 2009 003 110.3

(51) Int. Cl. H04N 13/02; G06K 9/00

(52) U.S. Cl. 348/46; 382/154; 348/E13.074

(57) ABSTRACT

An image processing method is described for determining depth information from at least two input images recorded by a stereo camera system, the depth information being determined from a disparity map taking into account geometric properties of the stereo camera system, characterized by the following method steps for ascertaining the disparity map: transforming the input images into signature images with the aid of a predefined operator, calculating costs based on the signature images with the aid of a parameter-free statistical rank correlation measure for ascertaining a cost range for predefined disparity levels in relation to at least one of the at least two input images, performing a correspondence analysis for each point of the cost range for the predefined disparity levels, the disparity to be determined corresponding to the lowest costs, and ascertaining the disparity map from the previously determined disparities.

### FIELD OF THE INVENTION

The present invention relates to an image processing method for determining depth information from at least two input images recorded with the aid of a stereo camera system, the depth information being calculated from a disparity map taking into account geometric properties of the stereo camera system. Moreover, the present invention relates to a computer program, a computer program product, and a device for executing such a method.

### BACKGROUND INFORMATION

Depth calculation on the basis of two stereo images is a standard problem in image processing and numerous algorithms are known for resolving this problem. Disparities d between time-synchronized and rectified stereo image pairs or stereo video image pairs are determined with the aid of stereo evaluation methods. As is apparent from FIG. 1, disparity d is defined as a one-dimensional displacement vector in the direction of the image line and indicates corresponding image point xj in right image A2 based on a pixel or image point xi in left image A1. The set of all disparities d with d=xj−xi′ is also referred to as a disparity map. xi′ refers to the image point projected by left image A1 into right image A2. The depth information of the stereo image may then be calculated with the aid of the disparity map taking into account the geometric properties of the stereo camera system. The ascertainment of correspondences between image points in the stereo images is significant with respect to the determination of disparities d. Feature-based methods or algorithms are often proposed for determining disparities d. An overview and comparison of these methods are provided in M. Z. Brown, D. Burschka, and G. D. Hager, “Advances in computational stereo,” IEEE Transactions on Pattern Analysis and Machine Intelligence, Vol. 25, no. 8, pages 993-1008, August 2003 [1] and D. Scharstein and R. Szeliski, “A taxonomy and evaluation of dense two-frame stereo correspondence algorithms,” International Journal of Computer Vision, Vol. 47, pages 7-42, April 2002 [2].

To calculate the disparity map, algorithmic method steps V, S1-S3 (in dashed frame), and N as shown in FIG. 2 are performed. The original image data are able to be manipulated with the aid of preparation steps V with respect to the selected stereo method (e.g., median filtering, rank transformation). A distance measure is calculated in first method step S1. Distance measures or correlation-based measures are often used. Depending on the particular distance measure used, the aggregation of costs performed in method step S2 may be performed directly in a pixel-wise manner or using windows. In particular, in the first case, assumptions regarding the smoothness, uniqueness, or the order of the disparities are taken into account as secondary conditions within the correspondence search in method step S3. The effort put into the correspondence search in method step S3 is often decisive for the density, robustness, and the reliability of the results and is defined by the used optimization technique. For example, the following optimization techniques are known from the related art: dynamic programming, scan line optimization, graph-based techniques, simulated annealing, and classic local methods. Post-processing may subsequently be performed in a method step N, particularly to remove apparently faulty areas, which may result, for example, from obstructions, from the disparity map and to achieve subpixel accuracy of the disparity estimation by interpolation in the previously ascertained cost range.

These stereo methods or stereo evaluation methods are based primarily on the minimization of cost functions (refer to publication [2]) which quantify the difference between image blocks from time-synchronously recorded image pairs of the stereo camera system. For this purpose, distance measures, such as the sum of the absolute differences (SAD), the sum of squared differences (SSD), and the cross correlation coefficient (CCC) or also simple Hamming distances between code words are often used after a suitable transformation and quantization of the image data (refer to publications [1] and [2]). The distance measure is a measure of the dissimilarity or difference. The decisive disadvantage of these methods for estimating stereo disparities based on real image sequence data is the insufficient invariance or robustness properties.

Therefore, the SAD criterion and SSD criterion implicitly require constancy of the average value of the data which is generally not given under real conditions. Although the versions of these criteria without an average value do not have this disadvantage, the invariance properties are still insufficient since simple scaling of the data, as may be caused by global lighting changes, for example, is not compensated. This is only possible by using the relatively computationally intensive above-mentioned CCC criterion, which, however, fails in the case of non-linear data errors as may occur due to local lighting changes. Methods based on Hamming distances between code words of transformed, quantized data are generally based on heuristic approaches so that the corresponding invariance properties cannot be determined analytically. The non-parametric rank transformation mentioned in [1] is also only a heuristic method.

It may therefore be summarized that the known methods for stereo evaluation for determining depth information or for 3D reconstruction on the basis of stereo camera systems or stereo video systems have one or more of the following disadvantages depending on the implementation variant:
The computational complexity exceeds the computing power of used embedded systems by one or more orders of magnitude.
The disparity estimations are present only for a fraction of less than 10% of image points, for example.
Disparity estimations have a significant percentage of gross measurement errors.
Disparity estimations have insufficient accuracy, e.g., a standard deviation in the order of magnitude of several disparity levels.

In general, reference is made to DE 102 19 788 C1 as the related art.

### SUMMARY OF THE INVENTION

The exemplary embodiments and/or exemplary methods of the present invention provide an image processing method for determining depth information from at least two time-synchronized and/or rectified input images recorded particularly stereoscopically with the aid of a stereo camera system, in particular including at least two image sensors, the depth information being calculated or determined from a disparity map taking into account geometric properties of the stereo camera system, the method being characterized by the following method steps for determining the disparity map:
transforming the input images into signature images with the aid of a predefined operator;
calculating costs based on signature images via a parameter-free or non-parametric statistical rank correlation measure for ascertaining a cost range for predefined disparity levels in relation to at least one of the at least two input images;
performing a correspondence analysis for every point of the cost range for the predefined disparity levels, the disparity to be determined corresponding to the lowest costs; and
ascertaining the disparity map from the previously determined disparities.

The previously mentioned flaws of the known methods are advantageously completely eliminated by the image processing method according to the present invention. The image processing method according to the present invention for ascertaining stereo video disparities or the disparity on the basis of a statistical rank correlation measure does not have any of the mentioned limitations. The used parameter-free or non-parametric statistics of the data is invariant compared to monotonous, non-linear transformations. Parameter-free statistics deals with parameter-free statistical models and parameter-free statistical tests. Other conventional designations are non-parametric statistics or distribution-free statistics. The model structure is not previously defined. No assumptions regarding the probability distribution of examined variables are made. A rank correlation coefficient or a rank correlation measure is a parameter-free measure for correlations which may be used to measure the level of agreement between two stochastic variables without making assumptions regarding the parametric structure of the probability distribution of the variables. The method allows implementation on currently embedded systems, e.g. field programmable gate arrays (FPGA), dense estimation of disparities for generally more than 90% of the relevant image points, robust estimation of disparities with an outlier rate of generally less than 1% and a disparity estimation with an accuracy in the range of subpixels. In the image processing method according to the present invention, a statistical measure or a statistical metric is used instead of deterministic distance measures. The use of a statistical rank correlation is significantly mathematically motivated since the method may be attributed to a normalized correlation coefficient.

The input images may be rectified, partially rectified, or not rectified. Rectification or correction generally refers to the elimination of geometric distortions in image data, e.g., due to non-ideal imaging properties of the optics or small geometric manufacturing tolerances of the imager.

It is particularly advantageous when the Kendall's-Tau rank correlation coefficient or a variant of this coefficient is used as the non-parametric statistical rank correlation measure. The Kendall rank correlation measure is described for example in H. Abdi, Kendall rank correlation, in N. J. Salkind (Ed.): “Encyclopedia of Measurement and Statistics” Thousand Oaks (Calif.), 2007 [3] as introduced in 1938 in mathematical statistics. However, due to the relatively high computational effort for high-dimensional data, the method has not yet been used for practical implementations in the area of signal processing. The high performance of modern embedded systems and the application-specific design of the image processing method according to the present invention now allow use in the described and related application fields.

A signature image is an input image transformed with the aid of a predefined operator. A sign operator may be used as the predefined operator.

With the aid of the sign operator, the signs of the differences of image data, in particular grayscale values, of different image points of the particular input images in a randomly selectable sub-area of the input images may be determined and stored in the signature images.

According to the exemplary embodiments and/or exemplary methods of the present invention, it may also be provided that a considered image data pair is compatible with or corresponds with first image data of a first image point at corresponding positions of a first input image and a second input image and second image data of a second image point at corresponding positions of the first input image and the second input image in the randomly selectable sub-area of the first and second input images when the sign of the difference between the image data of the first image point in the first input image and the image data of the second image point in the first input image coincides with the sign of the difference between the image data of the first image point in the second input image and the image data of the second image point in the second input image or the signs at the corresponding positions of the first and second image points in the signature images of the first and second input images coincide.

In one embodiment of the image processing method according to the present invention, it may be provided that the Kendall's-Tau rank correlation coefficient is given by

$$t = \frac{2 \cdot ( f - g )}{n \cdot ( n - 1 )}$$

with −1≦t≦1 in the randomly selectable sub-area, f being the number of the compatible image data pairs, g being the number of the incompatible image data pairs, and n being the number of all considered image data pairs of the randomly selectable sub-area.

The rank correlation measure according to Kendall may be used as follows. There are pairs (A1i, A2i), (A1j, A2j) of considered data, e.g., grayscale values of image points in a randomly selectable sub-area of images A1 and A2 of a stereo video image pair. Only the signs of the differences, sign (A1j−A1i), sign (A2j−A2i), are to be determined as a significant calculation operation. If these signs agree, the considered data pair is compatible. Otherwise it is not compatible. If f refers to the number of the compatible data pairs and g refers to the number of the incompatible data pairs, the rank correlation measure according to Kendall is defined by

$$t = \frac{2 \cdot s}{n \cdot ( n - 1 )} ;$$

s=f−g; −1≦t≦1 and may be used for implementing the robust image processing method according to the present invention. Variants of the method that explicitly address the case of vanishing differences are also suitable for implementing the described stereo method but are not discussed in greater detail.

The stereo camera system may be designed as a stereo video system and the input images as input video images. Of course, CCD or CMOS cameras are able to be used as the image sensors. Moreover, it is also possible to use image sensors in other wavelength ranges, e.g., the infrared range, and to use thermographic cameras accordingly.

The exemplary embodiments and/or exemplary methods of the present invention provide a computer program having program code means or a computer program product having program code means stored on a computer-readable data carrier to execute the image processing method according to the present invention.

Also provided is a device, in particular a driver information system or a driver assistance system of a motor vehicle, having at least one stereo camera system or stereo video system, which has an image processing device designed for executing the image processing method according to the present invention or for executing the corresponding computer program.

The image processing method according to the present invention may be implemented as a computer program on an image processing device of a stereo camera system or stereo video system, in particular within the framework of a driver information system or driver assistance system of a motor vehicle, other approaches also being possible. The computer program may be stored in a storage element (e.g., ROM, EEPROM, or the like) of the image processing device for this purpose. The image processing method is executed by processing on the image processing device. The image processing device may have a microcomputer having a microprocessor, a field programmable gate array (FPGA), an application-specific integrated circuit (ASIC), a digital signal processor (DSP) or the like. The computer program may be stored on a computer-readable data carrier (diskette, CD, DVD, hard drive, USB memory stick, memory card, or the like) or on an internet server as a computer program product and may be transferred from there to the storage element of the image processing device.

Advantageous embodiments and refinements of the present invention result from the subclaims. An exemplary embodiment of the present invention is described on the basis of the drawings.

### BRIEF DESCRIPTION OF THE DRAWINGS

FIG. 1 schematically shows a stereo image pair for illustrating the disparity according to the related art.

FIG. 2 shows a simplified flow chart of the disparity estimation procedure in stereo evaluation methods according to the related art.

FIG. 3 shows a simplified schematic block diagram of a driver information system having a stereo video system.

FIG. 4 shows a simplified schematic diagram of an image processing method according to the present invention.

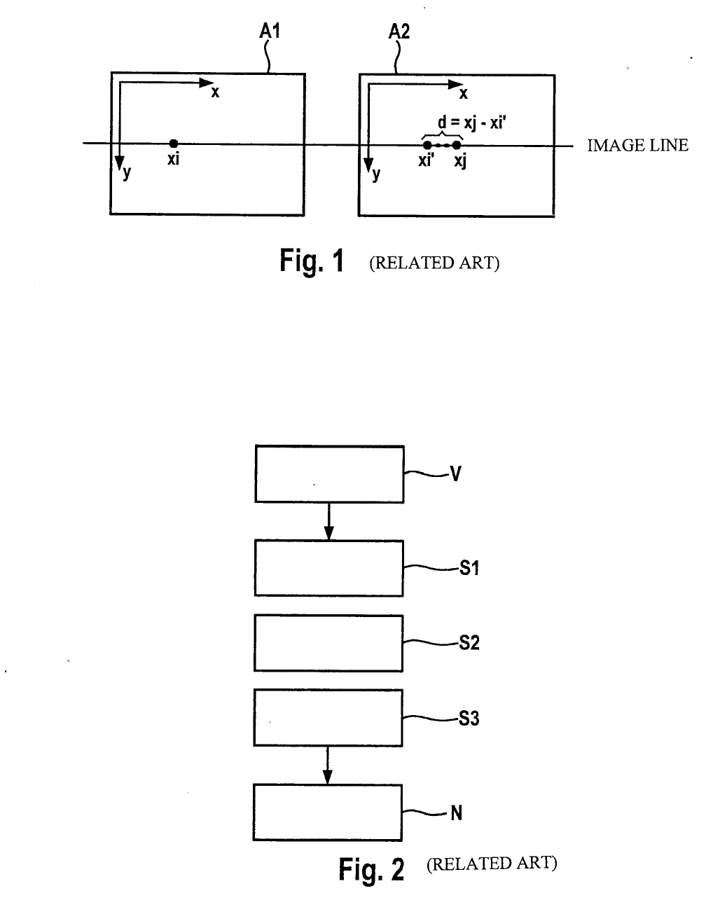

### DETAILED DESCRIPTION

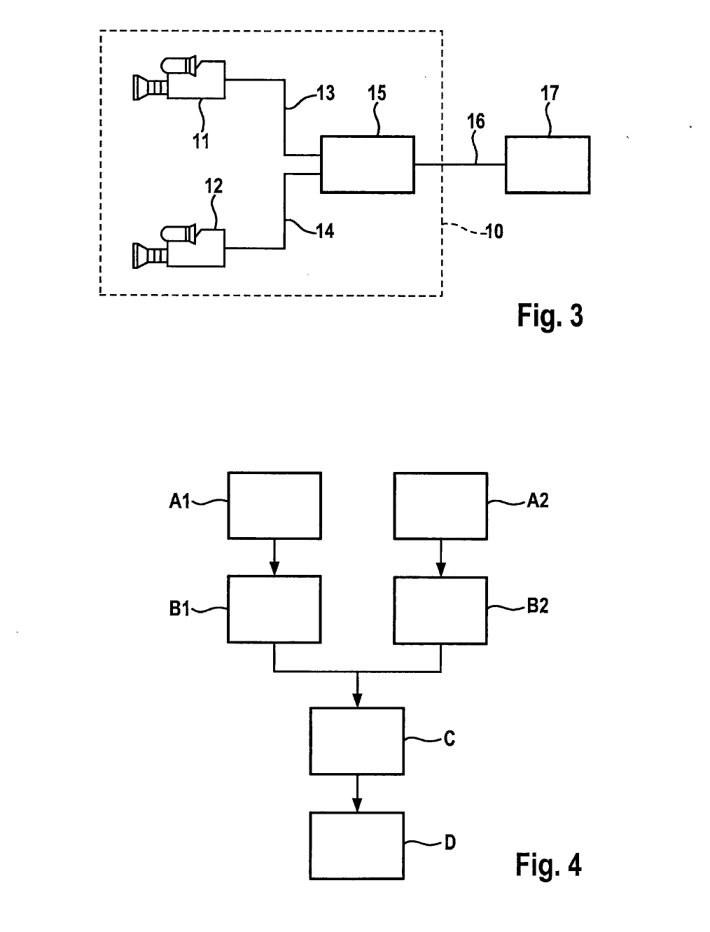

FIG. 3 shows a stereo camera system configured as a stereo video system 10 having two image sensors 11 and 12, two image sensor signal lines 13, 14, an evaluation unit or image processing device 15, an output signal line 16 and a subsequent system 17. For example, CCD or CMOS cameras or thermographic devices or the like may be used as image sensors 11, 12. Both image sensors 11, 12 are situated in such a way that they reproduce the same scenes but from a slightly different viewing angle. Image sensors 11, 12 transmit images of the observed scene to image processing device 15. On output signal line 16, image processing device 15 generates an output signal, which is transmitted electrically, digitally, acoustically, and/or visually for display, information, and/or saving to subsequent system 17. In the present exemplary embodiment, the subsequent system is a driver information system 17 of a vehicle (not shown) having stereo video system 10. In additional exemplary embodiments, subsequent system 17 could also be a driver assistance system of a motor vehicle or the like.

FIG. 4 schematically shows an image processing method according to the present invention for determining depth information from what may be at least two time-synchronized and rectified input images A1, A2 stereoscopically recorded with the aid of stereo camera system 10 having two image sensors 11, 12, depth information being determined or calculated from a disparity map taking into account geometric properties (in particular the basic distance between the two image sensors 11, 12) of stereo camera system 10. The image processing method according to the present invention is used for running a real-time stereo video system on the basis of a statistical rank correlation method. The rectified stereo video images or input video images A1, A2 are present as input data for real-time processing of the disparity map. The image processing method according to the present invention is characterized by the following method steps for ascertaining the disparity map:

A transformation of input images A1, A2 into signature images B1, B2 with the aid of a predefined operator is performed in a first method step. The grayscale values of video images A1, A2 are transformed into signature images B1, B2 in the first method step. A sign operator is used as the predefined operator for this purpose. In addition to the simple sign operator, more complex operators may be used in additional exemplary embodiments (not shown), which, for example, separately code an epsilon neighborhood of the zero point and adapt the threshold value to the local image information and/or determine only a suitable subset of the signatures for computing time reasons.

A cost calculation on the basis of signature images B1, B2 is performed in a second method step C with the aid of a non-parametric statistical rank correlation measure for ascertaining a cost range for predefined disparity levels in relation to at least one of the at least two input images A1, A2. The subsequent cost calculation for signature images B1, B2 is based on the statistical rank correlation measure or obvious variants of this metric, which may evaluate, for example, only a subset of available signatures in additional exemplary embodiments for computing time reasons. The resulting cost range (also referred to as the disparity space image/DSI) is ascertained in layers for the individual disparity levels, e.g., in relation to left output image A1. A Kendall's-Tau rank correlation coefficient or its variants is used as a non-parametric statistical rank correlation measure.

A correspondence analysis for each point of the cost range for the predefined disparity levels is then performed in a third method step D, disparity d to be determined corresponding to the lowest costs, whereupon the disparity map is subsequently ascertained in a fourth method step from previously determined disparities d. The correspondence analysis or correspondence search takes place within the cost range for each point in the direction of the disparity dimension. Ascertained disparity d corresponds to the correspondence having the lowest costs and is optimal. To prevent outliers, secondary conditions, e.g., the uniqueness of the cost minimum or also the local structuring of the cost function, are taken into account. The image processing method according to the present invention initially provides pixel-precise disparities d which may be refined in a further processing step as post-processing for determining a sub-pixel-precise disparity map.

With the aid of the sign operator, the signs of the differences of image data, in particular grayscale values, of different image points of the particular input video images A1, A2 in a randomly selectable sub-area of the input images are determined and stored in signature images B1, B2.

A considered image data pair is compatible with or corresponds with first image data of a first image point at corresponding positions of first input video image A1 and of second input video image A2 and second image data of a second image point at corresponding positions of first input video image A1 and of second input video image A2 in the randomly selectable sub-area of first and second input video images A1, A2 when the sign of the difference between the image data of the first image point in first input video image A1 and the image data of the second image point in second input video image A2 coincides with the sign of the difference between the image data of the first image point in second input video image A2 and the image data of the second image point in the second input video image or the signs at the corresponding positions of the first and second image points in signature images B1, B2 of first and second input video images A1, A2 coincide.

In the randomly selectable sub-area, the Kendall's-Tau rank correlation coefficient is given by

$$t = \frac{2 \cdot ( f - g )}{n \cdot ( n - 1 )}$$

with −1≦t≦1, f being the number of the compatible image data pairs, g being the number of the incompatible image data pairs, and n being the number of all considered image data pairs of the randomly selectable sub-area.

The image processing method according to the present invention may be implemented as a computer program on image processing device 15 of stereo video system 10, in particular within the framework of driver information system 17 of the motor vehicle, other approaches also being possible, of course. The computer program may be stored in a storage element (e.g., ROM, EEPROM, or the like) of image processing device 15 for this purpose. The image processing method is executed by processing on image processing device 15. Image processing device 15 may have a microcomputer having a microprocessor, a field programmable gate array (FPGA), an application-specific integrated circuit (ASIC), a digital signal processor (DSP) or the like. The computer program may be stored on a computer-readable data carrier (diskette, CD, DVD, hard drive, USB memory stick, memory card, or the like) or on an internet server as a computer program product and may be transferred from there to the storage element of image processing device 15.

### NON-PATENT LITERATURE

[1] M. Z. Brown, D. Burschka, and G. D. Hager, “Advances in computational stereo,” IEEE Transactions on Pattern Analysis and Machine Intelligence, Vol. 25, no. 8, pages 993-1008, August 2003;
[2] D. Scharstein and R. Szeliski, “A taxonomy and evaluation of dense two-frame stereo correspondence algorithms,” International Journal of Computer Vision, Vol. 47, pages 7-42, April 2002;
[3] H. Abdi, Kendall rank correlation. In N. J. Salkind (Ed.):

“Encyclopedia of Measurement and Statistics,” Thousand Oaks (Calif.), 2007.

1-10. (canceled)

11. An image processing method for determining depth information from at least two input images recorded by a stereo camera system, the method comprising:
determining the depth information being determined from a disparity map taking into account geometric properties of the stereo camera system; and
determining the disparity map by performing the following:
transforming the input images into signature images with the aid of a predefined operator;
calculating costs based on the signature images with the aid of a parameter-free statistical rank correlation measure for ascertaining a cost range for predefined disparity levels in relation to at least one of the at least two input images;
performing a correspondence analysis for each point of the cost range for the predefined disparity levels, the disparity to be determined corresponding with the lowest costs; and
ascertaining the disparity map from the previously determined disparities.

12. The image processing method of claim 11, wherein one of the Kendall's-Tau rank correlation coefficient and its variant is used as the non-parametric statistical rank correlation measure.

13. The image processing method of claim 11, wherein a sign operator is used as the predefined operator.

14. The image processing method of claim 13, wherein, with the aid of the sign operator, the signs of the differences of image data, in particular grayscale values, of different image points of the particular input images are determined in a randomly selectable sub-area of the input images and stored in the signature images.

15. The image processing method of claim 14, wherein a considered image data pair is compatible with or corresponds with first image data of a first image point at corresponding positions of a first input image and a second input image and second image data of a second image point at corresponding positions of the first input image and the second input image in the randomly selectable sub-area of the first and second input images when the sign of the difference between the image data of the first image point in the first input image and the image data of the second image point in the first input image coincides with the sign of the difference between the image data of the first image point in the second input image and the image data of the second image point in the second input image, or the signs at the corresponding positions of the first and second image points in the signature images of the first and second input images coincide.

16. The image processing method of claim 15, wherein the Kendall's-Tau rank correlation coefficient is given by
$$t = \frac{2 \cdot ( f - g )}{n \cdot ( n - 1 )}$$
with −1≦t≦1 in the randomly selectable sub-area, f being the number of the compatible image data pairs, g being the number of the incompatible image data pairs, and n being the number of all considered image data pairs of the randomly selectable sub-area.

17. The image processing method of claim 11, wherein the stereo camera system is designed as a stereo video system and the input images as input video images.

18. A computer readable medium having a computer program, which is executable by a processor, comprising:
a program code arrangement having program code for performing an image processing task for determining depth information from at least two input images recorded by a stereo camera system, by performing the following:
determining the depth information being determined from a disparity map taking into account geometric properties of the stereo camera system; and
determining the disparity map by performing the following:
transforming the input images into signature images with the aid of a predefined operator;
calculating costs based on the signature images with the aid of a parameter-free statistical rank correlation measure for ascertaining a cost range for predefined disparity levels in relation to at least one of the at least two input images;
performing a correspondence analysis for each point of the cost range for the predefined disparity levels, the disparity to be determined corresponding with the lowest costs; and
ascertaining the disparity map from the previously determined disparities;
wherein the computer program is executed on an image processing device of a stereo camera system, which is on one of a microprocessor of a microcomputer, a field programmable gate array, an application-specific integrated circuit, and a digital signal processor.

19. The computer readable medium of claim 18, wherein one of the Kendall's-Tau rank correlation coefficient and its variant is used as the non-parametric statistical rank correlation measure.

20. A driver information system of a motor vehicle, comprising:
at least one stereo camera system having an image processing device, provided with the at least one stereo camera system; and
a computer readable medium having a computer program, which is executable by a processor, including:
a program code arrangement having program code for performing an image processing task for determining depth information from at least two input images recorded by a stereo camera system, by performing the following:
determining the depth information being determined from a disparity map taking into account geometric properties of the stereo camera system; and
determining the disparity map by performing the following:
transforming the input images into signature images with the aid of a predefined operator;
calculating costs based on the signature images with the aid of a parameter-free statistical rank correlation measure for ascertaining a cost range for predefined disparity levels in relation to at least one of the at least two input images;
performing a correspondence analysis for each point of the cost range for the predefined disparity levels, the disparity to be determined corresponding with the lowest costs; and
ascertaining the disparity map from the previously determined disparities;
wherein the computer program is executed on an image processing device of a stereo camera system, which is on one of a microprocessor of a microcomputer, a field programmable gate array, an application-specific integrated circuit, and a digital signal processor.
